(19) United States
(12) Patent Application Publication
(10) Pub. No.: US 2017/0277200 A1
(43) Pub. Date: Sep. 28, 2017

(54) METHOD FOR CONTROLLING UNMANNED AERIAL VEHICLE TO FOLLOW FACE ROTATION AND DEVICE THEREOF

(71) Applicant: BEIJING ZERO ZERO INFINITY TECHNOLOGY CO., LTD, Beijing (CN)

(72) Inventors: Mengqiu WANG, Beijing (CN); Tong ZHANG, Beijing (CN); Qicheng LI, Beijing (CN); Jia LU, Beijing (CN); Lixin LIU, Beijing (CN)

(73) Assignee: Beijing Zero Zero Infinity Technology Co., Ltd, Beijing (CN)

(21) Appl. No.: 15/504,790

(22) PCT Filed: Jan. 11, 2016
(86) PCT No.: PCT/CN2016/070582

§ 371 Date: Feb. 17, 2017

(30) Foreign Application Priority Data
Sep. 24, 2015 (CN) 201510616735.1

(51) Int. Cl. G05D 1/08; G06K 9/00; G05D 1/02; B64C 19/00; B64C 39/02

(52) U.S. Cl. CPC G05D 1/0825; B64C 19/00; B64C 39/024; G05D 1/0202; G06K 9/00221; B64C 2201/146

(57) ABSTRACT

A method and a device for controlling an unmanned aerial vehicle (UAV) to follow face rotation are provided. The UAV is provided with a camera, the method includes: detecting a face in an image based on the Viola-Jones face detection framework; tracking the face and determining two-dimensional position of the facial feature on the face in pixel coordinates; obtaining three-dimensional position of the facial feature in world coordinates by looking up a standard three-dimensional face database; obtaining the three-dimensional position, in camera-centered coordinates, of the face on the UAV based on the two-dimensional position of the facial feature in the pixel coordinates and the three-dimensional position of the facial feature in world coordinates; and controlling, based on the three-dimensional position, in camera-centered coordinates, of the face on the UAV, the UAV to adjust its position to make the camera is aligned to the face.

The present application claims the priority to Chinese patent application No. 201510616735.1, titled “METHOD FOR CONTROLLING UNMANNED AERIAL VEHICLE TO FOLLOW FACE ROTATION AND DEVICE THEREOF”, filed with the State Intellectual Property Office of China on Sep. 24, 2015, the entire disclosure of which is incorporated herein by reference.

### FIELD

The disclosure relates to the technical field of unmanned aerial vehicle control, and in particular to a method for controlling an unmanned aerial vehicle to follow face rotation and a device thereof.

### BACKGROUND

In the conventional technology, unmanned aerial vehicle (UAV) control methods can be categorized into two ways: traditional remote controlled and mobile phone controlled. In the traditional remote controlled way, the UAV is controlled by both hands manipulating a four-directional operating stick. The mobile phone controlled way is generally implemented with an adaptation of the traditional two-hand controlled operating stick to a mobile phone.

The UAV in the conventional technology is often used to take a photo or record a video. However, the face may rotate during photo taking or video recording; to shoot a frontal face, real-time remote control of the position of the UAV is needed so that the camera on the UAV is aligned to the face. One has to master remote control techniques during the alignment, whether it is the traditional remote controlled way or the mobile phone controlled way; otherwise, the UAV may crash and damage may be caused.

Hence, it is desired by those skilled in the art that a method for controlling a UAV to follow face rotation and a device thereof are provided, so that the UAV automatically follows face rotation.

### SUMMARY

A technical problem to be solved by the present disclosure is to provide a method for controlling a UAV to follow face rotation and a device thereof.

A method for controlling a UAV to follow face rotation is provided according to an embodiment of the present disclosure, where the UAV is provided with a camera, and the method includes:

detecting a face in an image based on a Viola-Jones face detecting framework;

tracking the face and determining two-dimensional position of the facial feature on the face in pixel coordinates;

obtaining three-dimensional position of the facial feature on the face in world coordinates by looking up a standard three-dimensional face database, the standard three-dimensional face database being pre-acquired;

obtaining the three-dimensional position, in camera-centered coordinates, of the face on the UAV based on the two-dimensional position of the facial feature on the face in pixel coordinates and the three-dimensional position of the facial feature on the face in world coordinates; and

controlling, based on the three-dimensional position, in camera-centered coordinates, of the face on the UAV, the UAV to adjust a position of the camera to make the camera is aligned to the face.

Preferably, before detecting the face in the image based on the Viola-Jones face detecting framework, the method may further includes:

acquiring a variety of pictures containing faces from the Internet as samples;

labeling the faces in the sample and capturing the labeled faces; and

performing classification and training on the captured faces using Haar-like features to obtain a face detection model.

Preferably, the tracking the face and determining two-dimensional coordinates of the facial feature on the face in the image may include:

identifying a position of the facial feature on the face in the image in a current frame by tracking the face;

predicting, based on the Lucas-Kanade algorithm, a position of the facial feature on the face in the image in a next frame based on the position of the facial feature on the face in the image in the current frame;

obtaining a displacement of the facial feature on the face in the image between the two adjacent frames based on the position of the facial feature on the face in the image in the current frame and the position of the facial feature on the face in the image in the next frame; and

determining that tracking is successful in a case that the displacement falls within a preset maximum movement range, wherein the position of the facial feature on the face in the image in the next frame is taken as the two-dimensional position of the facial feature on the face in pixel coordinates.

Preferably, the obtaining the three-dimensional position, in camera-centered coordinates, of the face on the UAV based on the two-dimensional position of the facial feature on the face in pixel coordinates and the three-dimensional position of the facial feature on the face in world coordinates may include:

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}x \\ y \\ z \\ 1\end{matrix} ] ,$$

where

$$s [ \begin{matrix}u \\ v \\ 1\end{matrix} ]$$

is the two-dimensional position of the facial feature on the face in pixel coordinates;

$$[ \begin{matrix}x \\ y \\ z \\ 1\end{matrix} ]$$

is three-dimensional position of the facial feature on the face in the image;

$$[ \begin{matrix}{f}_{x} & 0 & {c}_{x} \\ 0 & {f}_{y} & {c}_{y} \\ 0 & 0 & 1\end{matrix} ]$$

is an intrinsic matrix of the camera; and

$$[ \begin{matrix}R & T\end{matrix} ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ]$$

is an extrinsic matrix of the camera, with R being an orientation displacement of the camera relative to the face, and T being a translation displacement of the camera relative to the face.

Preferably, the controlling the unmanned aerial vehicle to adjust a position of the UAV to make the camera is aligned to the face may include:

controlling, based on R and T, the unmanned aerial vehicle to fly to R0 and T0 along a predetermined flight trajectory, where R0 and T0 are respectively a target orientation displacement and a target translation displacement of the camera relative to the face when the camera aims at the face.

A device for controlling an unmanned aerial vehicle to follow face rotation is further provided according to the embodiments of the present disclosure, which includes:

a detecting unit configured to detect a face in an image based on a Viola-Jones face detection framework;

a tracking unit configured to track the face and determine two-dimensional position of the facial feature on the face in pixel coordinates;

a three-dimensional coordinate obtaining unit configured to obtain three-dimensional position of the facial feature on the face in world coordinates by looking up a standard three-dimensional face database, the standard three-dimensional face database being pre-acquired;

a relative coordinate obtaining unit configured to obtain the three-dimensional position, in camera-centered coordinates, of the face on the UAV based on the two-dimensional position of the facial feature on the face in pixel coordinates and the three-dimensional position of the facial feature on the face in world coordinates; and

an adjusting unit configured to control, based on the three-dimensional position, in camera-centered coordinates, of the face on the UAV, the UAV to adjust a position of the UAV to make the camera is aligned to the face.

Preferably, the device for controlling an unmanned aerial vehicle to follow face rotation may further include:

a sample acquiring unit configured to acquire a variety of pictures containing a face from the Internet as samples;

a face capturing unit configured to label the faces in the sample and capture the labeled faces; and

a model obtaining unit configured to perform classification and training on the captured faces using Haar-like features to obtain a face detection model.

Preferably, the tracking unit may include:

a position identifying sub-unit configured to identify a position of the facial feature on the face in the image in a current frame by tracking the face;

a predicting sub-unit configured to predict, based on the Lucas-Kanade algorithm, a position of the facial feature on the face in the image in a next frame based on the position of the facial feature on the face in the image in the current frame;

a displacement acquiring sub-unit configured to obtain a displacement of the facial feature on the face in the image between the two adjacent frames from the position of the facial feature in the current frame and the position of the facial feature in the next frame; and

a determining sub-unit configured to determine that tracking is successful in a case that the displacement falls within a preset maximum movement range, wherein the position of the facial feature on the face in the image in the next frame is taken as the two-dimensional position of the facial feature on the face in pixel coordinates.

Preferably, the relative coordinates obtaining unit may be configured to obtain the three-dimensional coordinates of the face relative to the camera on the unmanned aerial vehicle based on the following formula:

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}x \\ y \\ z \\ 1\end{matrix} ] ,$$

where

$$s [ \begin{matrix}u \\ v \\ 1\end{matrix} ]$$

is the two-dimensional coordinates of the facial feature on the face in the image;

$$[ \begin{matrix}x \\ y \\ z \\ 1\end{matrix} ]$$

is three-dimensional coordinates of the facial feature on the face in the image;

$$[ \begin{matrix}{f}_{x} & 0 & {c}_{x} \\ 0 & {f}_{y} & {c}_{y} \\ 0 & 0 & 1\end{matrix} ]$$

is an intrinsic matrix of the camera; and

$$[ \begin{matrix}R & T\end{matrix} ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ]$$

is an extrinsic matrix of the camera, with R being an orientation displacement of the camera relative to the face, and T being a translation displacement of the camera relative to the face.

Preferably, the adjusting unit may include an adjusting sub-unit configured to control, based on R and T, the unmanned aerial vehicle to fly to R0 and T0 along a predetermined flight trajectory, where R0 and T0 are respectively a target orientation displacement and a target translation displacement of the camera relative to the face when the camera is aligned to the face.

Compared with the conventional technology, the present disclosure can provide the following advantages.

With the method according to the present disclosure, the three-dimensional position of the face in camera-centered coordinates is acquired through face detection and tracking a facial feature on the face, and the position of the UAV is adjusted so that the camera is aligned to the face, which may be realized by adjusting the three-dimensional position of the face in camera-centered coordinates so that it is a standard position. This is because the three-dimensional position of the face in camera-centered coordinates is a known standard position when the camera is aligned to the face. By using the method according to the present disclosure, the UAV can move following face rotation during the UAV's tracking of a user to take a photo or record a video, which ensures that the lens of the camera on the UAV is aligned to a frontal face at all times.

### BRIEF DESCRIPTION OF THE DRAWINGS

In order to illustrate the technical solutions according to the embodiments of the present disclosure and in the conventional art more clearly, accompanying drawings used in the descriptions of the embodiments and the conventional art will be described briefly hereinafter. Apparently, the drawings described hereinafter are only some embodiments of the present disclosure, and other drawings may be obtained by those skilled in the art according to those drawings without inventive effort.

FIG. 1 is a schematic diagram of a first embodiment of a method for controlling a UAV to follow face rotation according to the present disclosure;

FIG. 2 is a schematic diagram of an application scenario where the camera on the UAV is aligned to the face according to the present disclosure;

FIG. 3 is a schematic diagram of a second embodiment of a method for controlling a UAV to follow face rotation according to the present disclosure;

FIG. 4 is a schematic diagram of a first embodiment of a device for controlling a UAV to follow face rotation according to the present disclosure; and

FIG. 5 is a schematic diagram of a second embodiment of a device for controlling a UAV to follow face rotation according to the present disclosure.

### DETAILED DESCRIPTION OF EMBODIMENTS

Technical solutions according to the embodiments of the present disclosure are described clearly and completely in conjunction with the drawings in the embodiments of the present disclosure hereinafter. Apparently, the described embodiments are only a few rather than all of the embodiments of the present disclosure. Other embodiments obtained by those skilled in the art without inventive effort based on the embodiments of the present disclosure fall into the scope of protection of the present disclosure.

To make the above features and advantages of the disclosure more apparent and easier to be understood, hereinafter specific embodiments of the disclosure are illustrated in detail in conjunction with the drawings.

### First Method Embodiment

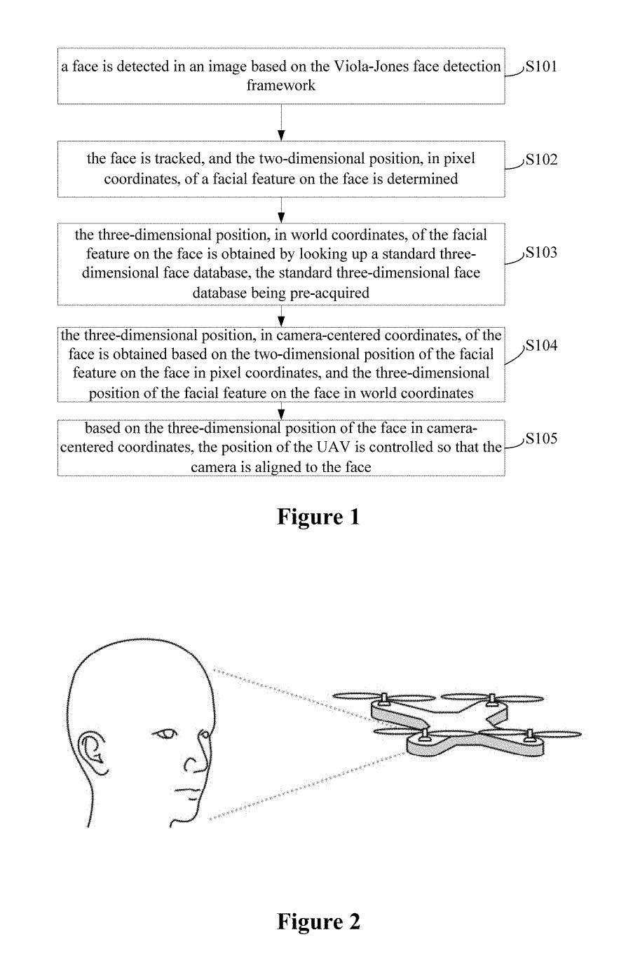

Referring to FIG. 1, FIG. 1 is a schematic diagram of a first embodiment of a method for controlling a UAV to follow face rotation according to the present disclosure.

The method for controlling a UAV to follow face rotation is provided according to the embodiment, where the UAV is provided with a camera, and the method includes steps S101 to S105.

In step S101, a face is detected in an image based on the Viola-Jones face detection framework.

It is to be noted that, the image shot by the camera on the UAV includes a face, and the face in the image may be detected based on the Viola-Jones face detection framework.

In step S102, the face is tracked, and the two-dimensional position, in pixel coordinates, of a facial feature on the face is determined.

In step S103, the three-dimensional position, in world coordinates, of the facial feature on the face is obtained by looking up a standard three-dimensional face database, the standard three-dimensional face database being pre-acquired.

It is to be noted that, the three-dimensional position, in world coordinates, of the facial feature on the face is a relative position of the facial feature, such as eye, nose and mouth, on the face. In the present disclosure, the coordinates of relative positions of facial features on a face may be stored in a standard three-dimensional face database in advance to be a reference standard, and when in use, retrieved from the standard three-dimensional face database.

In step S104, the three-dimensional position, in camera-centered coordinates, of the face is obtained based on the two-dimensional position of the facial feature on the face in pixel coordinates, and the three-dimensional position of the facial feature on the face in world coordinates.

It is to be understood that, the three-dimensional position, in camera-centered coordinates, of the face is also a relative position. To obtain the three-dimensional position of the face in camera-centered coordinates is to acquire the current position of the UAV.

In step S105, based on the three-dimensional position of the face in camera-centered coordinates, the position of the UAV is controlled so that the camera is aligned to the face.

It is to be noted that, the target position of the UAV is known, that is, the target position of the UAV is where the camera on the UAV is aligned to the face; and, at that point, the three-dimensional position of the face in camera-centered coordinates is the pre-determined standard position. When the camera is not aligned to the face, the three-dimensional position of the face in camera-centered coordinates deviates from the pre-determined standard position.

To allow a better photo taking or video recording by the camera on the UAV on the face, the position of the UAV is controlled so that the camera is aligned to the face, and the three-dimensional position of the face in camera-centered coordinates meets the pre-determined standard position.

With the method according to the present disclosure, the three-dimensional position of the face in camera-centered coordinates is acquired through face detection and tracking a facial feature on the face, and the position of the UAV is adjusted so that the camera is aligned to the face, which may be realized by adjusting the three-dimensional position of the face in camera-centered coordinates so that it is a standard position. This is because the three-dimensional position of the face in camera-centered coordinates is a known standard position when the camera is aligned to the face. By using the method according to the present disclosure, the UAV can move following face rotation during the UAV's tracking of a user to take a photo or record a video, which ensures that the lens of the camera on the UAV is aligned to a frontal face at all times.

Reference may be made to a schematic diagram of an application scenario as shown in FIG. 2.

The camera (not shown) on the UAV is aligned to the face, thereby ensuring the performance of photo taking or video taking.

### Second Method Embodiment

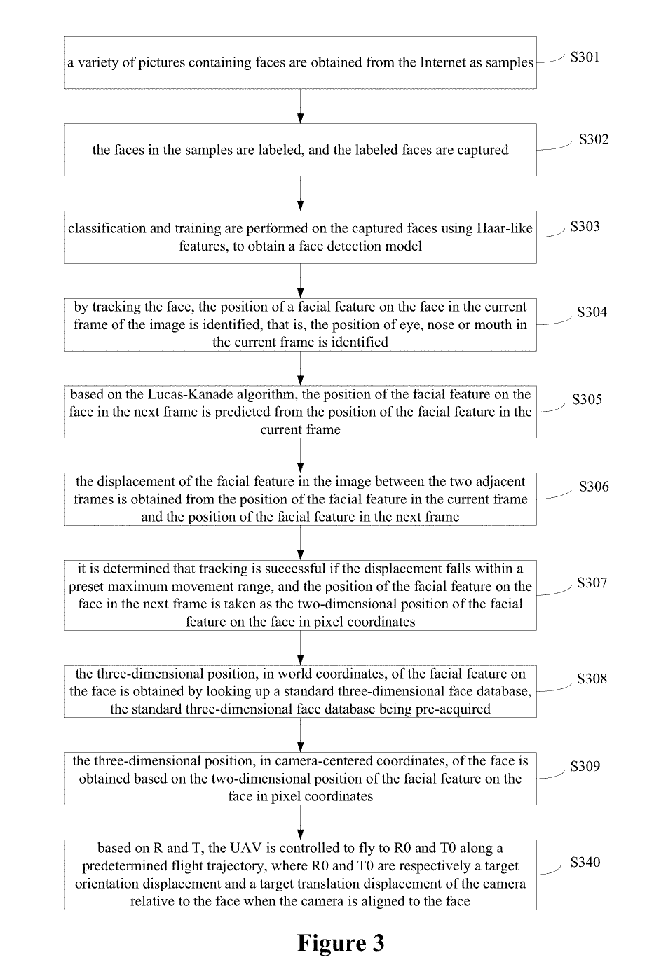

Reference is made to FIG. 3, a schematic diagram of a second embodiment of a method for controlling a UAV to follow face rotation according to the present disclosure.

Before detecting a face in an image based on the Viola-Jones face detection framework, the method for controlling the UAV to follow face rotation according to the embodiment may further includes steps S301 to S310.

In step S301, a variety of pictures containing faces are obtained from the Internet as samples.

In step S302, the faces in the samples are labeled, and the labeled faces are captured.

In step S303, classification and training are performed on the captured faces using Haar-like features, to obtain a face detection model.

It is to be noted that, the Viola-Jones face detection framework is known in the art but the present disclosure provides an improved face detection model in the Viola-Jones face detection framework. A significant amount of pictures containing faces are obtained from the Internet as samples; face regions are labeled manually in the samples, and the labeled face regions are captured.

It is to be understood that Haar-like features are known in the art, a detailed description of which is therefore omitted.

The tracking the face and determining the two-dimensional position of a facial feature on the face in pixel coordinates may include steps S304 to S307.

In step S304, by tracking the face, the position of a facial feature on the face in the current frame of the image is identified, that is, the position of eye, nose or mouth in the current frame is identified.

In step S305, based on the Lucas-Kanade algorithm, the position of the facial feature on the face in the next frame is predicted from the position of the facial feature in the current frame.

When the face rotates normally, the position of the facial feature in the next frame is predictable based on the Lucas-Kanade algorithm.

In step S306, the displacement of the facial feature in the image between the two adjacent frames is obtained from the position of the facial feature in the current frame and the position of the facial feature in the next frame.

In S307, it is determined that tracking is successful if the displacement falls within a preset maximum movement range, and the position of the facial feature on the face in the next frame is taken as the two-dimensional position of the facial feature on the face in pixel coordinates.

It is to be noted that, the preset maximum movement range is a maximum of the movement of the face between the two adjacent frames when the face rotates normally. Tracking fails if the displacement is determined to be greater than the preset maximum movement range; the tracking is successful if the displacement is determined to be less than the preset maximum movement range, and the position of the facial feature on the face in the next frame is taken as the two-dimensional position of the facial feature on the face in pixel coordinates.

It is determined that tacking fails if the displacement falls outside the preset maximum movement range. The process returns to step S304 for tracking until the tracking is successful.

In step S308, the three-dimensional position, in world coordinates, of the facial feature on the face is obtained by looking up a standard three-dimensional face database, the standard three-dimensional face database being pre-acquired.

It is to be noted that, the standard three-dimensional face database may store only one set of three-dimensional coordinates; that is, the relative position of the facial feature on the face in world coordinates is predetermined. It may be assumed that the relative positions of the facial feature on the faces of all people are the same. As a matter of course, the standard three-dimensional face database may also include N sets of three-dimensional coordinates, and the three-dimensional position of the facial feature on the face in world coordinates may be obtained from averaging the N sets of three-dimensional coordinates.

In step S309, the three-dimensional position, in camera-centered coordinates, of the face is obtained based on the two-dimensional position of the facial feature on the face in pixel coordinates, and the three-dimensional position of the facial feature on the face in world coordinates, specifically:

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}x \\ y \\ z \\ 1\end{matrix} ] ,$$

where

$$s [ \begin{matrix}u \\ v \\ 1\end{matrix} ]$$

is the two-dimensional coordinates of the facial feature on the face in the pixel coordinates;

$$[ \begin{matrix}x \\ y \\ z \\ 1\end{matrix} ]$$

is the three-dimensional position of the facial feature on the face in the world coordinates;

$$[ \begin{matrix}{f}_{x} & 0 & {c}_{x} \\ 0 & {f}_{y} & {c}_{y} \\ 0 & 0 & 1\end{matrix} ]$$

is an intrinsic matrix of the camera; and

$$[ \begin{matrix}R & T\end{matrix} ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ]$$

is an extrinsic matrix of the camera, with R being an orientation displacement of the camera relative to the face, and T being a translation displacement of the camera relative to the face.

It is to be noted that, the intrinsic matrix of the camera and the extrinsic matrix of the camera are known matrices.

In step S310, the position of the UAV is controlled so that the camera is aligned to the face, specifically:

based on R and T, the UAV is controlled to fly to R0 and T0 along a predetermined flight trajectory, where R0 and T0 are respectively a target orientation displacement and a target translation displacement of the camera relative to the face when the camera is aligned to the face.

It is to be understood that, R0 and T0 are respectively a preset standard orientation displacement and a preset standard translation displacement, the target position being where the UAV is when the camera is aligned to the face. Hence, at the target position, the coordinates of the position of the face in camera-centered coordinates are known.

With the method according to the present disclosure, the position of the face in the next frame is predicated based on the Lucas-Kanade algorithm, to track the face. And when tracking is successful, the position of the UAV is adjusted so that the camera on the UAV is aligned to the face. Therefore, it can be ensured that the camera on the UAV is aligned to the face in the course of shooting, thereby ensuring the image quality of the face in the image.

Based on the method for controlling a UAV to follow face rotation according to the above embodiments, a device for controlling the UAV to follow face rotation is further provided according to the embodiments of the present disclosure, which is described in detail hereinafter in conjunction with the drawings.

### First Device Embodiment

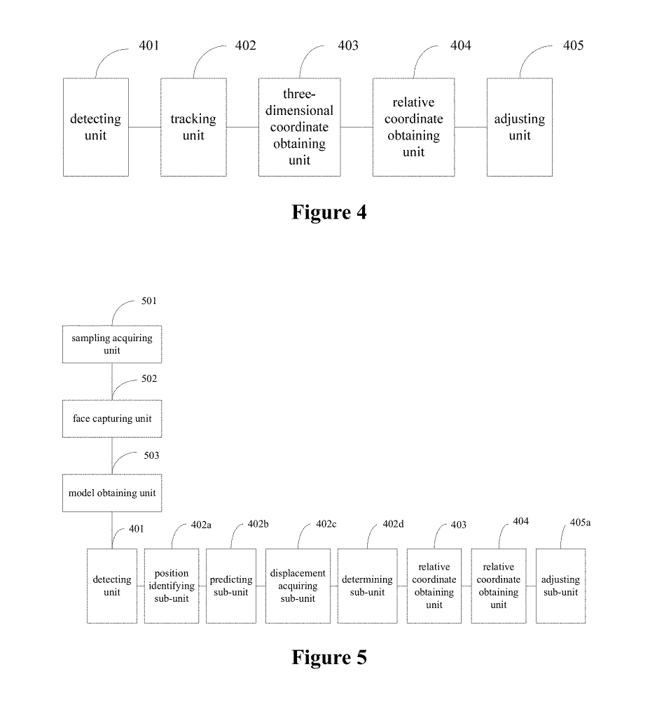

Referring to FIG. 4, FIG. 4 is a schematic diagram of a first embodiment of a device for controlling a UAV to follow face rotation according to the present disclosure.

The device for controlling a UAV to follow face rotation according to the embodiment of the present disclosure includes a detecting unit 401, a tracking unit 402, a three-dimensional coordinate obtaining unit 403, a relative coordinate obtaining unit 404 and an adjusting unit 405.

The detecting unit 401 is configured to detect a face in an image based on a Viola-Jones face detection framework.

It is to be noted that, the image shot by the camera on the UAV includes the face, and the face in the image may be detected based on the Viola-Jones face detection framework.

The tracking unit 402 is configured to track the face and determine two-dimensional position of the facial feature on the face in pixel coordinates.

The three-dimensional coordinate obtaining unit 403 is configured to obtain three-dimensional position of the facial feature on the face in world coordinates by looking up a standard three-dimensional face database, the standard three-dimensional face database being pre-acquired.

It is to be noted that, the three-dimensional position, in world coordinates, of the facial feature on the face is a relative position of the facial feature, such as eye, nose and mouth, on the face. In the present disclosure, the coordinates of relative positions of facial features on a face may be stored in a standard three-dimensional face database in advance to be a reference standard, and when in use, retrieved from the standard three-dimensional face database.

It is to be noted that, there may only be one three-dimensional coordinate in the standard three-dimensional face database. Three-dimensional coordinates of relative positions of the five sense organs on the face in the world coordinate system are preset. It may be assumed that relative positions of five sense organs on faces of all the people are the same. Practically, the standard three-dimensional face database may include N three-dimensional coordinates, and the N three-dimensional coordinates may be averaged to obtain the three-dimensional position of the facial feature on the face in world coordinates.

The relative coordinate obtaining unit 404 is configured to obtain the three-dimensional position, in camera-centered coordinates, of the face on the UAV based on the two-dimensional position of the facial feature on the face in pixel coordinates and the three-dimensional coordinates of the five sense organs on the face in world coordinate system.

It is to be understood that, the three-dimensional position, in camera-centered coordinates, of the face on the UAV are also relative coordinates. A purpose of obtaining the three-dimensional position, in camera-centered coordinates, of the face on the UAV is to obtain a current position of the UAV.

The adjusting unit 405 is configured to control, based on the three-dimensional position, in camera-centered coordinates, of the face on the UAV, the UAV to adjust the position of the UAV to make the camera is aligned to the face.

It is to be noted that, a target position of the UAV is known. That is, when the camera on the UAV aims at the face, the three-dimensional position, in camera-centered coordinates, of the face on the UAV are the preset standard coordinates. When the camera does not aim at the face, the three-dimensional position, in camera-centered coordinates, of the face on the UAV deviates from the set standard coordinates.

To allow the camera on the UAV to take a picture or record a video for the face better, the UAV is to be controlled to adjust its position, so that the camera on the UAV is aligned to the face, and thus the three-dimensional position, in camera-centered coordinates, of the face on the UAV reach the standard coordinates.

With the device according to the present disclosure, the three-dimensional position of the face in camera-centered coordinates is acquired through face detection and tracking a facial feature on the face, and the position of the UAV is adjusted so that the camera is aligned to the face, which may be realized by adjusting the three-dimensional position of the face in camera-centered coordinates so that it is a standard position. This is because the three-dimensional position of the face in camera-centered coordinates is a known standard position when the camera is aligned to the face. By using the device according to the present disclosure, the UAV can move following face rotation during the UAV's tracking of a user to take a photo or record a video, which ensures that the lens of the camera on the UAV is aligned to a frontal face at all time.

Reference may be made to a schematic diagram of a practical application scenario as shown in FIG. 2.

The camera (not shown in FIG. 2) on the UAV is aligned to the face, thereby ensuring an effect of taking a picture or recording a video.

### Second Device Embodiment

Referring to FIG. 5, FIG. 5 is a schematic diagram of a second embodiment of a device for controlling a UAV to follow face rotation according to the present disclosure.

The device according to the embodiment further include a sampling acquiring unit 501, a face capturing unit 502 and a model obtaining unit 503.

The sample acquiring unit 501 is configured to acquire a variety of pictures containing faces from the Internet as samples.

The face capturing unit 502 is configured to label the faces in the sample and capture the labeled faces.

The model obtaining unit 503 is configured to perform classification and training on the captured faces using Haar-like features, to obtain a face detection model.

It is to be noted that, the Viola-Jones face detection framework is known in the art but the present disclosure provides an improved face detection model in the Viola-Jones face detection framework. A significant amount of pictures containing faces are obtained from the Internet as samples; face regions are labeled manually in the samples, and the labeled face regions are captured.

It is to be understood that Haar-like features are known in the art, a detailed description of which is therefore omitted.

The tracking unit 402 in the device according to the embodiment includes a position identifying sub-unit 402a, a predicting sub-unit 402b, a displacement acquiring sub-unit 402c and a determining sub-unit 402d.

The position identifying sub-unit 402a is configured to identify the position of the facial feature on the face in the current frame of the image by tracking the face.

The predicting sub-unit 402b is configured to predict, based on the Lucas-Kanade algorithm, the position of the facial feature on the face in the next frame from the position of the facial feature in the current frame.

The displacement acquiring sub-unit 402c is configured to obtain the displacement of the facial feature in the image between the two adjacent frames from the position of the facial feature in the current frame and the position of the facial feature in the next frame.

The determining sub-unit 402d is configured to determine that tracking is successful if the displacement falls within a preset maximum movement range, and the position of the facial feature on the face in the image in the next frame is taken as the two-dimensional position of the facial feature on the face in pixel coordinates.

The position of the facial feature on the face in the image in a next frame may be predicted based on the Lucas-Kanade algorithm in a case that the face rotates normally.

It is to be noted that, the preset maximum movement range is a maximum of the movement of the face between the two adjacent frames when the face rotates normally. Tracking fails if the displacement is determined to be greater than the preset maximum movement range; the tracking is successful if the displacement is determined to be less than the preset maximum movement range, and the position of the facial feature on the face in the next frame is taken as the two-dimensional position of the facial feature on the face in pixel coordinates.

It is determined that tacking fails if the displacement falls outside the preset maximum movement range. The process returns to step 5304 for tracking until the tracking is successful.

The relative coordinates obtaining unit 404 is configured to obtain the three-dimensional coordinates of the face relative to the camera on the UAV based on the following formula:

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}x \\ y \\ z \\ 1\end{matrix} ] ,$$

where

$$s [ \begin{matrix}u \\ v \\ 1\end{matrix} ]$$

is the two-dimensional position of the facial feature on the face in the pixel coordinates;

$$[ \begin{matrix}x \\ y \\ z \\ 1\end{matrix} ]$$

is the three-dimensional position of the facial feature on the face in the world coordinates;

$$[ \begin{matrix}{f}_{x} & 0 & {c}_{x} \\ 0 & {f}_{y} & {c}_{y} \\ 0 & 0 & 1\end{matrix} ]$$

is an intrinsic matrix of the camera; and

$$[ \begin{matrix}R & T\end{matrix} ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ]$$

is an extrinsic matrix of the camera, with R being an orientation displacement of the camera relative to the face, and T being a translation displacement of the camera relative to the face.

It is to be noted that, the intrinsic matrix of the camera and the extrinsic matrix of the camera each are known matrices.

The adjusting unit 405 includes the adjusting sub-unit 405a configured to control, based on R and T, the UAV to fly to R0 and T0 along a predetermined flight trajectory, where R0 and T0 are respectively a target orientation displacement and a target translation displacement of the camera relative to the face when the camera aims at the face.

It is to be understood that, R0 and T0 are respectively a preset standard orientation displacement and a preset standard translation displacement, the target position being where the UAV is when the camera is aligned to the face. Hence, at the target position, the coordinates of the position of the face in camera-centered coordinates are known.

With the device according to the present disclosure, the position of the face in the image in the next frame is predicted based on the Lucas-Kanade algorithm, to track the face. And when tracking is successful, the position of the UAV is adjusted so that the camera on the UAV is aligned to the face. Therefore, it can be ensured that the camera on the UAV is aligned to the face in the course of shooting, thereby ensuring the image quality of the face in the image.

What is described above is only preferred embodiments of the present disclosure and is not intended to limit the present disclosure in form. Preferred embodiments of the present disclosure are disclosed above, which should not be interpreted as limiting the present disclosure. Numerous alternations, modifications, and equivalents can be made to the technical solution of the present disclosure by those skilled in the art in light of the methods and technical content disclosed herein without deviation from the scope of the present disclosure. Therefore, any alternations, modifications, and equivalents made to the embodiments above according to the technical essential of the present disclosure without deviation from the scope of the present disclosure should fall within the scope of protection of the present disclosure.

1. A method for controlling an unmanned aerial vehicle to follow face rotation, wherein the unmanned aerial vehicle is provided with a camera, the method comprises:
detecting a face in an image based on a Viola-Jones face detection framework;
tracking the face and determining two-dimensional position of the facial feature on the face in pixel coordinates;
obtaining three-dimensional position of the facial feature on the face in world coordinates by looking up a standard three-dimensional face database, the standard three-dimensional face database being pre-acquired;
obtaining the three-dimensional position, in camera-centered coordinates, of the face on the unmanned aerial vehicle based on the two-dimensional position of the facial feature on the face in pixel coordinates and the three-dimensional position of the facial feature on the face in world coordinates; and
controlling, based on the three-dimensional position, in camera-centered coordinates, of the face on the unmanned aerial vehicle, the unmanned aerial vehicle to adjust a position of the unmanned aerial vehicle to make the camera is aligned to the face.

2. The method for controlling an unmanned aerial vehicle to follow face rotation according to claim 1, wherein before detecting the face in the image based on Viola-Jones face detection framework, the method further comprises:
acquiring a variety of pictures containing faces from the Internet as samples;
labeling the faces in the sample and capturing the labeled faces; and
performing classification and training on the captured faces using Haar-like features to obtain a face detection model.

3. The method for controlling an unmanned aerial vehicle to follow face rotation according to claim 1, wherein the tracking the face and determining two-dimensional position of the facial feature on the face in pixel coordinates comprises:
identifying a position of the facial feature on the face in the image in a current frame by tracking the face;
predicting, based on the Lucas-Kanade algorithm, a position of the facial feature on the face in the image in a next frame based on the position of the facial feature on the face in the image in the current frame;
obtaining a displacement of the facial feature on the face in the image between the two adjacent frames based on the position of the facial feature on the face in the image in the current frame and the position of the facial feature on the face in the image in the next frame; and
determining that tracking is successful in a case that the displacement falls within a preset maximum movement range, wherein the position of the facial feature on the face in the image in the next frame is taken as the two-dimensional position of the facial feature on the face in pixel coordinates.

4. The method for controlling an unmanned aerial vehicle to follow face rotation according to claim 3, wherein the obtaining the three-dimensional position, in camera-centered coordinates, of the face on the unmanned aerial vehicle based on the two-dimensional position of the facial feature on the face in pixel coordinates and the three-dimensional position of the facial feature on the face in world coordinates comprises:
$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}x \\ y \\ z \\ 1\end{matrix} ] ,$$
wherein
$$s [ \begin{matrix}u \\ v \\ 1\end{matrix} ]$$
is the two-dimensional position of the facial feature on the face in the pixel coordinates;
$$[ \begin{matrix}x \\ y \\ z \\ 1\end{matrix} ]$$
is three-dimensional coordinates of the facial feature on the face in the world coordinates;
$$[ \begin{matrix}{f}_{x} & 0 & {c}_{x} \\ 0 & {f}_{y} & {c}_{y} \\ 0 & 0 & 1\end{matrix} ]$$
is an intrinsic matrix of the camera; and
$$[ \begin{matrix}R & T\end{matrix} ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ]$$
is an extrinsic matrix of the camera, with R being an orientation displacement of the camera relative to the face, and T being a translation displacement of the camera relative to the face.

5. The method for controlling an unmanned aerial vehicle to follow face rotation according to claim 4, wherein controlling the unmanned aerial vehicle to adjust a position of the unmanned aerial vehicle to make the camera is aligned to the face comprises:
controlling, based on R and T, the unmanned aerial vehicle to fly to R0 and T0 along a predetermined flight trajectory, wherein R0 and T0 are respectively a target orientation displacement and a target translation displacement of the camera relative to the face when the camera is aligned to the face.

6. A device for controlling an unmanned aerial vehicle to follow face rotation, comprising:
a detecting unit configured to detect a face in an image based on a Viola-Jones face detection framework;
a tracking unit configured to track the face and determine two-dimensional position of the facial feature on the face in pixel coordinates;
a three-dimensional coordinate obtaining unit configured to obtain three-dimensional position of the facial feature on the face in world coordinates by looking up a standard three-dimensional face database, the standard three-dimensional face database being pre-acquired;
a relative coordinate obtaining unit configured to obtain the three-dimensional position, in camera-centered coordinates, of the face on the unmanned aerial vehicle based on the two-dimensional position of the facial feature on the face in pixel coordinates and the three-dimensional position of the facial feature on the face in world coordinates; and
an adjusting unit configured to control, based on the three-dimensional position, in camera-centered coordinates, of the face on the unmanned aerial vehicle, the unmanned aerial vehicle to adjust a position of the unmanned aerial vehicle to make the camera is aligned to the face.

7. The device for controlling an unmanned aerial vehicle to follow face rotation according to claim 6, further comprising:
a sample acquiring unit configured to acquire a variety of pictures containing a face from the Internet as samples;
a face capturing unit configured to label the faces in the sample and capture the labeled faces; and
a model obtaining unit configured to perform classification and training on the captured faces using Haar-like features to obtain a face detection model.

8. The device for controlling an unmanned aerial vehicle to follow face rotation according to claim 6, wherein the tracking unit comprises:
a position identifying sub-unit configured to identify a position of the facial feature on the face in the image in a current frame by tracking the face;
a predicting sub-unit configured to predict, based on the Lucas-Kanade algorithm, a position of the facial feature on the face in the image in a next frame based on the position of the facial feature on the face in the image in the current frame;
a displacement acquiring sub-unit configured to obtain a displacement of the facial feature on the face in the image between the two adjacent frames from the position of the facial feature in the current frame and the position of the facial feature in the next frame; and
a determining sub-unit configured to determine that tracking is successful in a case that the displacement falls within a preset maximum movement range, wherein the position of the facial feature on the face in the image in the next frame is taken as the two-dimensional position of the facial feature on the face in pixel coordinates.

9. The device for controlling an unmanned aerial vehicle to follow face rotation according to claim 8, wherein the relative coordinates obtaining unit is configured to obtain the three-dimensional coordinates of the face relative to the camera on the unmanned aerial vehicle based on the following formula:
$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}x \\ y \\ z \\ 1\end{matrix} ] ,$$
where
$$s [ \begin{matrix}u \\ v \\ 1\end{matrix} ]$$
is the two-dimensional position of the facial feature on the face in the pixel coordinates;
$$[ \begin{matrix}x \\ y \\ z \\ 1\end{matrix} ]$$
is three-dimensional coordinates of the facial feature on the face in the world coordinates;
$$[ \begin{matrix}{f}_{x} & 0 & {c}_{x} \\ 0 & {f}_{y} & {c}_{y} \\ 0 & 0 & 1\end{matrix} ]$$
is an intrinsic matrix of the camera; and
$$[ \begin{matrix}R & T\end{matrix} ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ]$$
is an extrinsic matrix of the camera, with R being an orientation displacement of the camera relative to the face, and T being a translation displacement of the camera relative to the face.

10. The device for controlling an unmanned aerial vehicle to follow face rotation according to claim 9, wherein the adjusting unit comprises an adjusting sub-unit configured to control, based on R and T, the unmanned aerial vehicle to fly to R0 and T0 along a predetermined flight trajectory, wherein R0 and T0 are respectively a target orientation displacement and a target translation displacement of the camera relative to the face when the camera is aligned to the face.
